(19) United States
(12) Patent Application Publication
(10) Pub. No.: US 2008/0212397 A1
(43) Pub. Date: Sep. 4, 2008

(54) Method and Apparatus to Optimize the Mixing Process

(76) Inventor: Joel Rondeau, Clamart Cedex (FR)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/996,087

(22) PCT Filed: Jun. 29, 2006
(86) PCT No.: PCT/EP2006/006302

§ 371 Date: Jan. 18, 2008

(30) Foreign Application Priority Data
Jul. 22, 2005 (EP) 05291577.4

(51) Int. Cl. B01F 3/12; B01F 3/22; B01F 5/04; B01F 15/00; B01F 5/10; B28C 5/00

(52) U.S. Cl. 366/2; 366/167.1; 366/30; 366/154.1; 366/143; 366/151.1; 366/108; 366/348

(57) ABSTRACT

The invention discloses a system for mixing a liquid material and a solid material, said system comprising: i) a base unit (22′), for the liquid material and the solid material; ii) a liquid material supply (21); iii) a solid material supply (200); iv) a liquid/solid mixing output (23); and v) an injection unit (20) connected to the liquid material supply and to the solid material supply, said injection unit injecting said liquid material and said solid material in the base unit; vi) a separation and extraction unit (24) simultaneously separating surplus of gas coming from the mixing of the liquid material and the solid material and extracting from the base unit said surplus of gas. Further disclosed is a method for mixing a liquid material and a solid material, said method comprising the steps of: i) mixing the liquid material and the solid material to form a liquid/solid slurry; ii) separating and extracting simultaneously from said liquid/solid slurry surplus of gas coming from the mixing of the liquid and the solid material; and iii) extracting from said liquid/solid slurry a liquid/solid material substantially without gas.

### FIELD OF THE INVENTION

The present invention broadly relates to mixing system. More particularly the invention relates to an apparatus and related method for mixing a liquid material and a solid material to obtain a slurry in a cost, time and performance efficiency way. The apparatus removes any gas or air surplus in the solid/liquid mixing and improves the mixing process. In particular the invention provides a system for the continuous mixing of cements or other fluids used in the drilling, completion or stimulation of boreholes such as oil or gas wells.

### DESCRIPTION OF THE PRIOR ART

When a well such as an oil or gas well has been drilled, it is often desired to isolate the various producing zones from each other or from the well itself in order to stabilize the well or prevent fluid communication between the zones or shut off unwanted fluid production such as water. This isolation is typically achieved by installing a tubular casing in the well and filling the annulus between the outside of the casing and the wall of the well (the formation) with cement. The cement is usually placed in the annulus by pumping slurry of the cement down the casing such that it exits at the bottom of the well and passes back up the outside of the casing to fill the annulus. While it is possible to mix the cement as a batch prior to pumping into the well, it has become desirable to effect continuous and optimized mixing of the cement slurry at the surface just prior to pumping into the well. This has been found to provide better control of cement properties and more efficient use of materials.

The cement slurries used in such operations comprise a mixture of dry and liquid materials. The liquid phase is typically water and so is readily available and cheap. The solid materials define the slurry and cement properties when added to the water and mixed. FIGS. 1 and 2 show a schematic diagram of a prior art mixing system. In FIG. 1, solid materials are delivered to the mixer 10 directly from a surge can 8 via a flow control valve 6 and are carried into the mixing tub 5 with the mix water. The water is delivered via a first water supply 1, and optionally via a second water supply 7 when the amount of water can not be efficiently delivered via the first supply 1 for pressure and flow rate problems. The contents of the mixing tub 5 are recirculated with a pump 4, generally a centrifugal pump, through a recirculation pipe 11 to the mixer 10 via a recirculation input 2. An output 3 is provided for slurry to be pumped into the well. In FIG. 2, solid materials are delivered to the mixer 10 from a silo via a direct feeding 18 controlled by a flow control valve 16 and are carried into the mixing tub 5 with the mix water. The other parts of the mixing system of FIG. 2 are similar to those of the mixing system of FIG. 1. U.S. Pat. No. 4,007,921 discloses such a type of mixer for mixing dry particles with a liquid.

Actually, when using mixing systems of prior art, problems occur in efficiency of the mixing process. Problems occur when mixing a solid component and a liquid component, the obtained slurry contains a surplus of gas which impacts on the performance of the mixing process. The solid component, first to ensure a rapid mixing and secondly to be easily carried and introduced in the mixer, is at the state of granular or powder with natural interstitial voids containing air. The solid component can also be fluidized with air to make the solid component more fluid, especially when used with a silo. All this entrapped air will become a serious problem when the liquid and solid components will be mixed. Entrapped air upsets centrifugal pump by decreasing its performance and therefore performance of all the mixing system.

The present invention seeks to provide a mixing system which avoids the cited problems.

### SUMMARY OF THE INVENTION

The invention provides a system for mixing a liquid material and a solid material, said system comprising: (i) a base unit, for the liquid material and the solid material; (ii) a liquid material supply; (iii) a solid material supply; (iv) a liquid/solid mixing output; (v) an injection unit connected to the liquid material supply and to the solid material supply and the injection unit injecting said liquid material and said solid material in the base unit; (vi) a separation and extraction unit separating and extracting simultaneously from the base unit surplus of gas coming from the mixing of the liquid material and the solid material.

Preferably, the mixing system further comprises an extraction unit connected to the liquid/solid mixing output and extracting a liquid/solid material substantially without gas from the base unit.

Preferably, the base unit ensures the mixing of the liquid material and the solid material. More preferably, the base unit is a base cyclic unit ensuring recirculation of the liquid material and the solid material through a recirculation input in the injection means. So the base cyclic unit ensures the mixing of the liquid material and the solid material. The recirculation ensures a better efficiency in the mixing process and avoids wasting not perfectly mixed slurry.

In a preferred embodiment, the system applies to cement slurry, the liquid material being an aqueous solution (water, solid additives, other liquid additives) and the solid material being cement blend. To mix cement slurry, the mixing system has to have performances in quality, in cost and in time. The proposed mixing system has all these features due to its rapid, compact and efficient characteristics.

Preferably, the separation and extraction unit is a conical cyclonic unit, preferably of the type hydrocyclone. The cyclonic unit ensures an efficient separation and extraction of gas from the slurry rapidly and costless. The cyclonic unit is further resistant to problems of corrosion due to use of abrasive components or of erosion due to use of solid components in high speed. The separation and extraction unit can further comprise a gas surplus output, said gas surplus output being connected to surrounding atmosphere. No pressure equalization has to be done, because the gas will automatically go outside in the atmosphere.

Preferably, the injection unit further comprises the function of pre-mixing said liquid material and said solid material. More preferably, the injection unit is an injector with three nozzles coming respectively from the solid material supply, the liquid material supply, and the recirculation input, the first and second nozzles allowing a first mixing before a second mixing with the third nozzle. Preferably, the solid material is coming substantially perpendicularly to the liquid material, allowing a first mixing. The recirculation input is positioned parallel to the liquid material supply and below, so that the slurry coming from the recirculation input is mixed with the liquid material and the solid material after the first mixing. This configuration is suitable to ensure mixing in a cost and time efficient way. This injection unit is further resistant to problems of corrosion due to use of abrasive components or of erosion due to use of solid components in high speed.

In a preferred embodiment, the system further comprises a control system controlling the solid material supply; said control system being located at a distance sufficiently great from the injection unit to remain substantially dry. Preferably, the distance is sufficiently great to avoid splash from the mixer. The distance is preferably from some centimeters, preferably more than 5 centimeters, preferably more than 10 centimeters, preferably more than 20 centimeters depending on the diameter of the opening from the solid material supply to the mixer. A ratio distance on diameter is preferably greater than 2, preferably greater than 5, preferably greater than 10. Said distance sufficiently great is ensured with a tube, preferably transparent and/or flexible and/or sufficiently vacuum resistant, which is located between the control means and the injection unit. The tube further can comprise a pressure valve located between the control system and the injection unit. The pressure valve or vacuum breaker ensures that the mixer is not depressurized when the flow control valve is closed and that the pressure inside the tube remains substantially the same. The tube is also empty of solid material thanks to the pressure valve. The control system is preferably a knife gate which ensures a constant and repeatable flow rate of the solid material.

In another preferred embodiment, the system further comprises a perturbing system enhancing the delivery of the solid material, said perturbing system being located between the solid material supply and the injection unit. The perturbing system is any one of the system taken in the list constituted of: pneumatic vibration system, mechanical vibration system, acoustic vibration system, piezoelectric vibration system, electromagnetical vibration system.

In another aspect of the invention, a method is described for mixing a liquid material and a solid material, said method comprising the steps of: (i) mixing the liquid material and the solid material to form a liquid/solid slurry; (ii) separating and extracting simultaneously from said liquid/solid slurry surplus of gas coming from the mixing of the liquid material and the solid material; and (iii) extracting from said liquid/solid slurry a liquid/solid material substantially without gas.

The method can further comprise a recirculation step, where the liquid/solid slurry not extracted in step (iii) is re-injected in the liquid/solid slurry of step (i). The recirculation ensures a better efficiency in the mixing process and avoids wasting not perfectly mixed slurry.

The method can apply to mix cement slurry, the liquid material being an aqueous solution and the solid material being cement blend.

The step (ii) of separating and extracting simultaneously surplus of gas is done by conical cyclonic effect. The cyclonic effect ensures an efficient extraction of gas from the slurry rapidly and costless. The cyclonic effect is further independent on problem of resistant or problem of corrosion due to use of abrasive components or of erosion due to use of solid components in high speed.

The method can further comprise a step of pre-mixing the liquid material and the solid material before the step i) of mixing the liquid material and the solid material. Also, the step of pre-mixing the liquid material and the solid material comprises a vibration step to enhance delivery of the solid material.

### BRIEF DESCRIPTION OF THE DRAWINGS

Further embodiments of the present invention can be understood with the appended drawings:

FIG. 1 shows a schematic diagram of a mixing system with a surge can of solid material supply from Prior Art.

FIG. 2 shows a schematic diagram of a mixing system with a silo for solid material supply from Prior Art.

FIG. 3 shows a mixer from Prior Art.

FIG. 4 shows a schematic diagram of the mixing system according to the invention.

FIG. 5 shows a schematic diagram of a mixing system with a surge can of solid material supply.

FIG. 6 shows a schematic diagram of a mixing system with a silo for solid material supply.

FIG. 7 shows a schematic view of the principle of the separation gas/liquid/solid.

### DETAILED DESCRIPTION

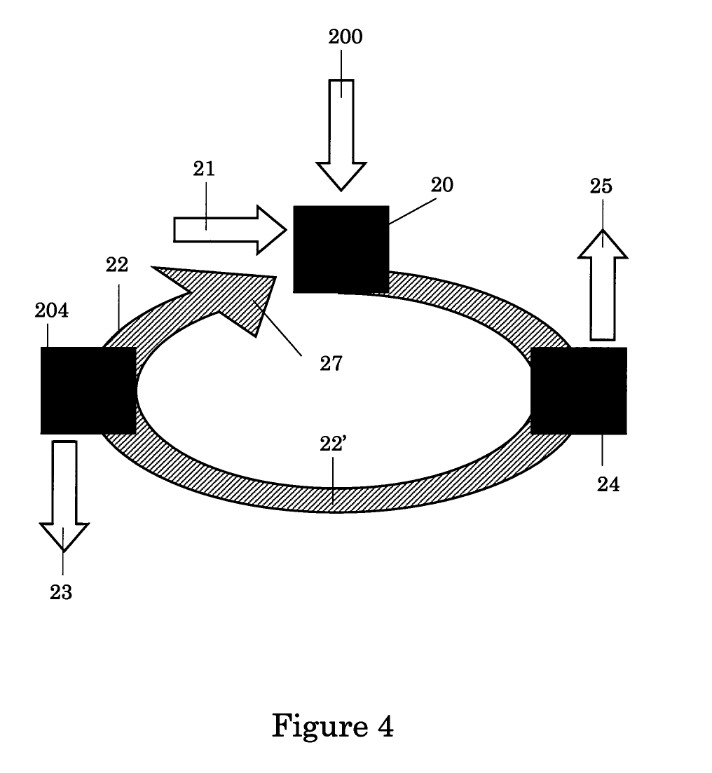

FIG. 4 is a schematic diagram of the mixing system according to the invention. The major improvement in the proposed mixing system is to eliminate the problem of gas surplus in the mixing process by removing totally or almost totally the gas present in the liquid/solid slurry; whereas the prior art solutions always deal with improving the mixing process by minimizing the gas surplus effect without removing this effect anyway. The mixing system comprises a base unit 22′ wherein the liquid material and the solid material can be mixed; a liquid material supply 21; a solid material supply 200; an injection unit 20 connected to the liquid material supply and to the solid material supply and injecting the liquid material and the solid material in the base unit; an separation and extraction unit 24 simultaneously separating and extracting from the base unit surplus of gas coming from the mixing of the liquid material and the solid material; and an extraction unit 204 connected to a liquid/solid mixing output 23 and extracting a solid/liquid material substantially without gas from the base unit. The separation and extraction unit has the advantage to separate and extract simultaneously the gas surplus and this separation and extraction step is made by the same unit. In a preferred embodiment the mixing system contains a recirculation loop and the base unit is a base cyclic unit 22 ensuring recirculation in the injection unit 20 through a recirculation input 27. The recirculation ensures a continuous mixing of the slurry and therefore a better mixing efficiency. The recirculation is done thanks to a pump present on the base cyclic unit 22. Preferably, the pump is located between the separation and extraction unit 24 and the extraction unit 204; the pump can be a centrifugal pump. Also, all the base unit and/or base cyclic unit have the rule of the mixing system.

The mixing system can be used for any type of mixing where a liquid component and a solid component comprising intrinsic gas or entrapped air due to its geometry or its composition have to be used. Especially, the mixing system applies when the solid component is at the state of granular or powder with natural interstitial voids containing air. The mixing system applies also when the solid component contains artificial injected air (when fluidized for example to ensure transportation). The mixing system applies also when the liquid component and the solid component are chemically reactive or when liquid component and solid component react chemically and produce a gas surplus.

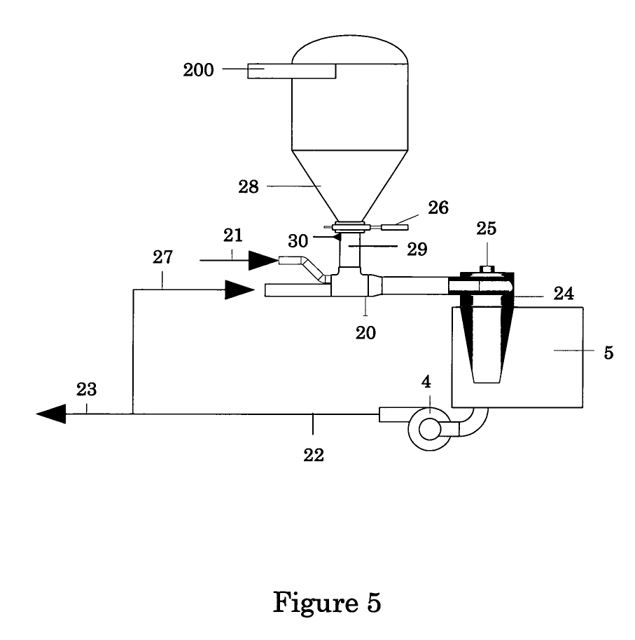

In the preferred embodiment the solid component is dry cement blend and the liquid component is a mixing fluid, which comprises water and other additives or aqueous solutions. FIG. 5 is a schematic diagram of a mixing system with a surge can 28. The solid materials are delivered to the injection unit 20 directly from the surge can 28 via a flow control valve 26. The cement is delivered to the surge can from a cement supply 200. And the mixing fluid is delivered to the injection unit from a mixing fluid supply 21. The solid materials are carried into the mixing tub 5 with the mixing fluid after have passed in a separation and extraction unit 24. The separation and extraction unit 24 separates the liquid/solid slurry content from the gas surplus. The gas surplus content is separated and extracted from the slurry and simultaneously ejected to the surrounding atmosphere via a gas surplus output 25. The contents of the mixing tub 5 are recirculated with a pump 4 through a recirculation pipe 22 to the injection unit 20 via a recirculation input 27. The pump 4 is preferably a centrifugal pump. An output 23 is provided for slurry to be pumped into the well.

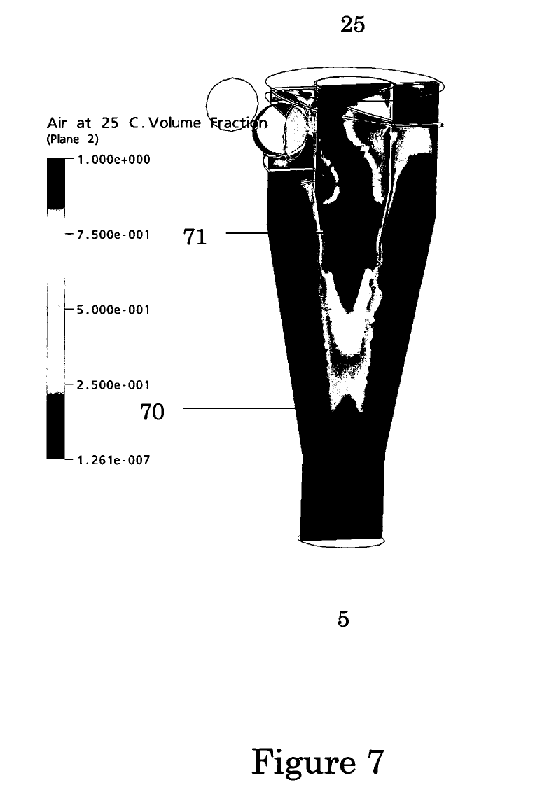

The separation and extraction unit 24 is preferably a conical cyclonic unit or hydrocyclone system. FIG. 7 is a schematic view of the principle of the separation and extraction unit. The conical cyclonic unit separates the liquid/solid slurry content from the gas surplus and is preferably of the type hydrocyclonic. Using centrifugation principle, the hydro cyclone 70 installed on the top of the mixing tub 5 separates air from liquid/solid slurry. The gas surplus output 25 is an exhaust pipe 71 in communication with the atmosphere. The exhaust pipe releases air in the atmosphere. In operation, the liquid/solid slurry is introduced into the conical hydrocyclonic unit. The tangential force causes the slurry to rotate at a high angular velocity, forcing heavier material (liquid/solid slurry) to the side walls where they continue downward with increasing velocity to the bottom of the cone section of the hydrocyclone. The cyclonic flow in the hydrocyclone creates a centrally located low pressure vortex where the lighter material (gas surplus) flows upward and exits the top of the hydrocyclone through the exhaust pipe 71 as shown on FIG. 7. The hydrocyclone is a rather simple, highly efficient sizing device with no moving internal parts.

A test has been realized with and without hydro cyclone before the mixing tub. When the exhaust pipe is closed (which corresponds to a mixing system without hydro cyclone) the total volume of the slurry present in the mixing system increases and we can evaluate that 7% of the volume of the slurry is air. Therefore, when the hydro cyclone functions at least 7% of the gas surplus or entrapped air present in the slurry is extracted. Furthermore, it has been shown that for prior art systems, 2% of air present in the slurry decreases the centrifugal pump efficiency of 10% i.e. the efficiency of the mixing system, and 4% of air present in the slurry decreases the centrifugal pump efficiency of 43%. A decreasing of 7% of air present in the slurry increases consequently in a large way the efficiency of the mixing system. The efficiency of the mixing system has a direct impact on the slurry quality (because with less air), on the mixing time (because with less air, the pump functions efficiently and rapidly).

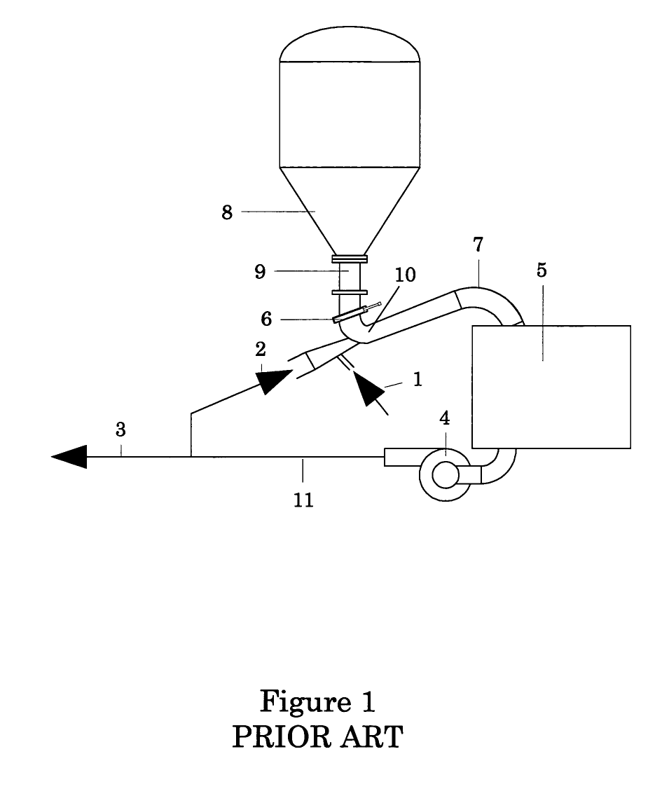

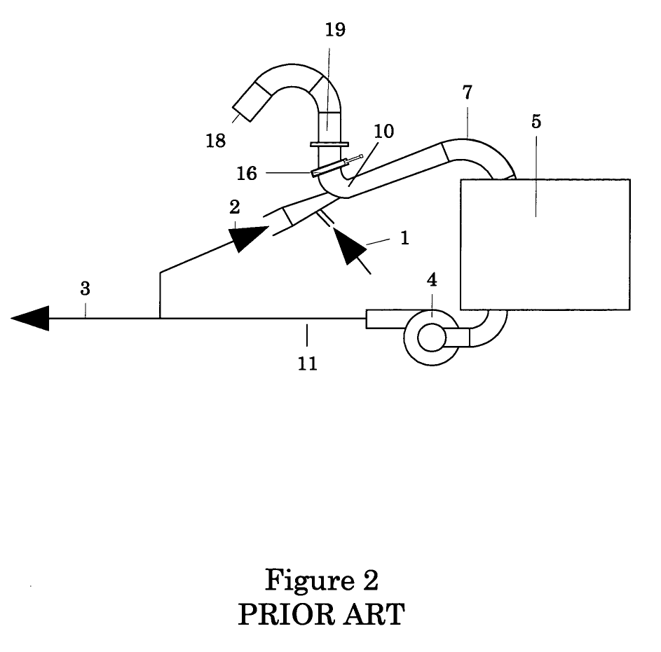

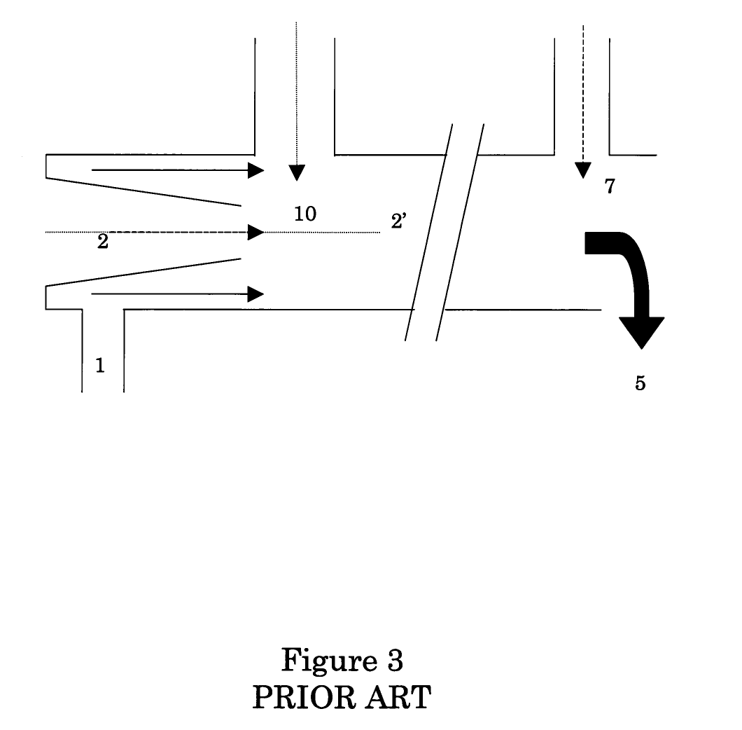

Additionally, in mixing systems FIGS. 1 and 2 of Prior Art, another problem occurs directly in the mixer 10. The mixer of prior art is disclosed in FIG. 3. The mixer contains a recirculation input nozzle 2 and a surrounding annular nozzle for the water supply 1 which supply respectively the liquid/solid slurry and the liquid component following an axis 2′. The solid component is delivered approximately perpendicularly to the axis 2′. Because the liquid component supply is annular, all the liquid component can not be mixed directly at this stage with the solid component. The annular supply does not allow a full flow. Effectively, the flow rate and the pressure being the maximum allowed for the liquid component supply 1, a part of the liquid component has to be added upstream via a second liquid supply 7 in the mixing tub 5. The mix between liquid and solid components occurs later and therefore the mixing efficiency is consequently reduced. Furthermore, a part of the liquid component mixed first with the solid component and another part of the liquid component mixed first with the liquid/solid slurry. This light delay causes inefficiency in the mixing process.

Also, in the preferred embodiment of the invention, the injection unit 20 further comprises the function of pre-mixing the liquid material and the solid material and more preferably the injection unit 20 is an injector with three nozzles or a tee mixing bowl. To the injection unit 20, three connection inputs or nozzles are coming, respectively: the cement supply (via the tube 29), the mixing fluid supply 21 and the recirculation input 27. The system is realized so that cement and mixing fluid are firstly mixed together before to be mixed with the recirculation liquid/solid slurry. The nozzle of the mixing fluid supply is substantially perpendicular to the nozzle of the cement supply; the nozzle of the recirculation is also substantially perpendicular to the nozzle of the cement supply and is located below the nozzle of the mixing fluid supply so that when the cement blend falls in the mixer, the cement blend is first in contact with mixing fluid and after with liquid/solid slurry. There is no need as in prior art systems to add a second mixing fluid supply, because all the mixing fluid can be delivered efficiently at this location. The mixing of the three components which are cement, mixing fluid and liquid/solid slurry is efficiently realized thanks to this configuration of the inputs. The efficiency of the mixer has a direct impact on the job quality and job performance.

Additionally, in mixing systems FIGS. 1 and 2 of Prior Art, another problem occurs just before the mixer 10 at the position of the valve 6 for the cement silo or valve 16 for the surge can. Due to architecture problem and position of the valve close to the liquid supply, the mixer is often blocked with dry solid or plugged with liquid/solid slurry. When the surrounding region (tube 9 and mixer 10) of the valve is completely blocked and can not ensure an efficient mixing process, the mixing system has to be dismantled to clean and remove the solid content blocking the apparatus. Mostly, this operation is costly, time consuming and especially not ecological. Effectively, when the tube 9 and the mixer 10 have to be cleaned from blocked “non-green” cement on a field location, generally the cement is emptied out of the mixer into the earth surface soiling the ground water. Furthermore, because dry solid or liquid/solid slurry blocked the exit of the valve, the predefined flow rate of the valve is changed. This change in the flow rate of the valve remains uncontrollable and independent of the solid component delivery.

Also, in the preferred embodiment of the invention, the dry cement is delivered to the injection unit 20 via the flow control valve 26. Between the flow control valve and the mixer a tube 29 is present, said tube has a length substantially great to deliver correctly the cement and to allow effective mixing in the mixer 20. As said previously, problem of mixer from prior art is that the exit of the flow control valve remains blocked with dry cement or plugged with liquid/solid slurry. By increasing the distance between the flow control valve and the mixer, the probability to have a blocked valve decreases. The distance is sufficiently great to avoid splash coming from the mixer and so that the flow control valve remains substantially dry. The tube 29 further comprises a pressure valve or vacuum breaker 30 located close to the flow control valve 26 and the pressure valve being in communication with surrounding atmosphere. The pressure valve allows to empty the tube correctly when the flow control valve is closed, avoids de-pressurization of the mixer when the flow control valve is closed and ensures a substantially constant pressure inside the tube. For example, when the flow control valve is open with a certain flow rate, the pressure valve is closed and the dry cement falls in the mixer 20. When the flow control valve is closed, the pressure inside the tube is not sufficient, the valve opens and the remaining cement present in the tube 29 falls in the mixer 20 whereas the tube is filled with air. The tube remains clean and no dry cement or liquid/solid slurry blocked the tube and furthermore, the tube remains dry because no depressurization of the mixer has occurred and no condensation has appeared on the surfaces of the tube. The skilled in the art will appreciate that thanks to the cyclonic unit 24, the air present in the tube is not a problem and will be extracted from the slurry. In a preferred embodiment the flow control valve is a knife gate or slide gate. The knife gate allows having a better regulation of the flow of dry cement blend when in powder. Effectively, the cement blend rate is constant, repeatable and independent of other parameters during the mixing process for a given opening of the knife gate. So, the knife gate has a constant and repeatable behavior. The tube is preferably transparent to allow control when the cement falls in the mixer and flexible to ensure easy removing. This new configuration of the flow control valve enhances the mixing efficiency. The efficiency of the mixer has a direct impact on the job quality and job performance (because the tube is not often blocked).

Also, in another preferred embodiment the injection unit comprises a perturbing system enhancing the delivery of the solid material. The perturbing system is located between the solid material supply and the injection unit, or close to the solid material supply or close to the injection unit (not shown on Figures). The perturbing system can be any type of device generating vibrations; we can cite for example pneumatic vibration system, mechanical vibration system, acoustic vibration system, piezoelectric vibration system, or electromagnetical vibration system. The vibration device or vibrator creates vibration with given amplitude (force) and frequency which are communicated to the mixer: especially the injection unit, and/or the solid material supply. In a preferred embodiment, the device is a pneumatic impact vibrator mounted outside on the injection input, which operates by cycles. Force and frequency of the impact break slurry clogs if already formed, or prevent their formation if not formed.

The extraction unit 204 is preferably an output line taken in the recirculation pipe 2. The output line can be optionally added of a pump, a flow meter. The output line delivers the cement slurry for operation in the well (not shown).

The mixing system can further comprise other devices not shown. For example, control of the slurry mixture can be achieved by controlling the density in the mixing tub with a densitometer. The densitometer is typically a non-radioactive device such as a Coriolis meter. A device for measuring the amount of liquid material or liquid/solid slurry can be added as a flow meter, a level sensor or a load sensor. Other pumps can be added to the mixing system to ensure transportation of liquid material or liquid/solid mixture. Other valves or flow control units can also be added to the mixing system.

In a further aspect of the invention, the mixing system can be easily automated. Effectively, because the proposed mixing system solved problems of prior art systems regarding air and cement blocking in the mixer or close to the flow control valve; the mixing process is simplify and independent, unavoidable and especially unpredictable events will no more happen. It has been noted that the knife gate has a constant and repeatable behavior. Therefore, a control device can be implemented to monitor the input of the flow rate of the solid material and the liquid material depending on the output of the flow rate of the liquid/solid slurry extracted. Alternatively, other parameters can be utilized for the monitoring as the liquid/solid slurry for recirculation, the gas surplus extracted, and the flow rate in the recirculation pipe depending on the pump 4.

The cement silo can further be replaced by several silos, each silo communicating with the control valve 26 when several solid components have to be mixed together. In the same way, the liquid supply can be replaced by several liquid supplies when several liquid components have to be mixed together. Or alternatively, mixing systems can be mounted in series. For example, when two solid components with a liquid component have to be mixed, two mixing system are mounted in series, each silo containing one of the solid components.

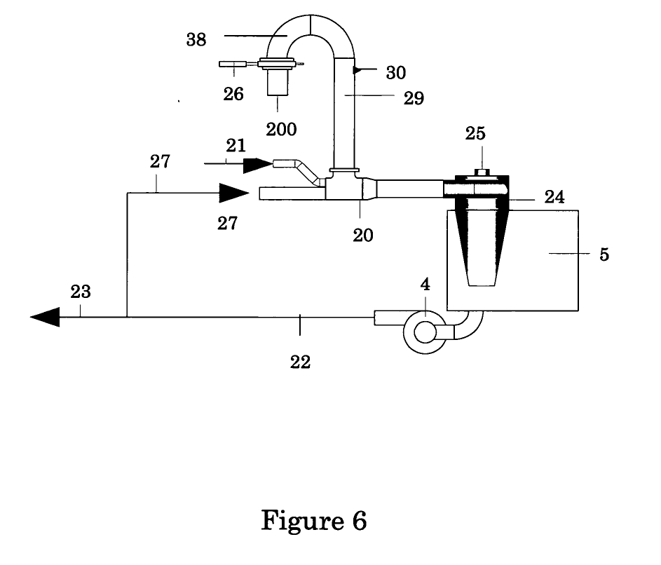

FIG. 6 is a schematic diagram of a mixing system with a direct feeding 38 or cement silo. The solid materials are delivered to the injection unit 20 directly from a cement supply 200 via a flow control valve 26. And the mixing fluid is delivered to the injection unit from a mixing fluid supply 21. The solid materials are carried into the mixing tub 5 with the mixing fluid after have passed in a cyclonic separation unit 24. The cyclonic unit 24 separates the liquid/solid slurry content from the gas surplus. The gas surplus content is extracted from the slurry and ejected to the surrounding atmosphere via a gas surplus output 25. The contents of the mixing tub 5 are recirculated with a pump 4 through a recirculation pipe 22 to the injection unit 20 via a recirculation input 27. The pump 4 is preferably a centrifugal pump. An output 23 is provided for slurry to be pumped into the well. The embodiments already disclosed for the mixing system with a surge can apply also for this mixing system with a direct feeding.

The present invention also disclosed a method for mixing slurry made of a liquid material and a solid material. The operation in the mixing process are first, to mix the liquid material and the solid material to form a liquid/solid slurry; secondly, to separate and extract simultaneously from the liquid/solid slurry obtained surplus of gas coming from the mixing of the liquid material and the solid material; and finally, to extract from the liquid/solid slurry a liquid/solid material substantially without gas. In a preferred embodiment, the mixing process can further comprise a recirculation step where the non extracted slurry of last step is re-injected at the beginning of the mix of the liquid/solid slurry. The recirculation ensures a continuous mixing of the slurry and therefore a better mixing efficiency. The method is directly applied to the mixing system described above.

1. A system for mixing a liquid material and a solid material, said system comprising:
i) a base unit, for the liquid material and the solid material;
ii) a liquid material supply;
iii) a solid material supply;
iv) a liquid/solid mixing output; and
v) an injection unit connected to the liquid material supply and to the solid material supply, said injection unit injecting said liquid material and said solid material in the base unit;
vi) a separation and extraction unit simultaneously separating surplus of gas coming from the mixing of the liquid material and the solid material and extracting from the base unit said surplus of gas.

2. The system of claim 1, further comprising an extraction unit connected to the liquid/solid mixing output and extracting a liquid/solid material substantially without gas from the base unit.

3. The system of claim 1, wherein the base unit ensures the mixing of the liquid material and the solid material.

4. The system of claim 1, wherein the base unit is a base cyclic unit ensuring recirculation of the liquid material and the solid material through a recirculation input in the injection unit.

5. The system of claim 1, wherein the mixing applied to a cement slurry, the liquid material being an aqueous solution and the solid material being cement blend.

6. The system of claim 1, wherein the separation and extraction unit is a conical cyclone.

7. The system of claim 1, wherein the separation and extraction unit further comprises a gas surplus output, said gas surplus output being connected to surrounding atmosphere.

8. The system of claim 1, wherein the injection unit further comprises the function of pre-mixing said liquid material and said solid material.

9. The system of claim 4, wherein the injection unit is an injector with three nozzles coming respectively from the solid material supply, the liquid material supply, and the recirculation input, the first and second nozzles allowing a first mixing before a second mixing with the third nozzle.

10. The system of claim 4, further comprising a control system controlling the solid material supply, said control system being located at a distance sufficiently great from the injection unit to remain substantially dry.

11. The system of claim 10, wherein a tub is located between the control system and the injection unit.

12. The system of claim 11, wherein the tub is transparent.

13. The system of claim 10, further comprising a pressure valve located between the control system and the injection unit.

14. The system of claim 4, wherein the control system is a knife gate.

15. The system of claim 1, wherein the mixing system is an automated system with a control device, said control device controlling the solid material supply.

16. The system of claim 1, further comprising a perturbing system enhancing the delivery of the solid material, said perturbing system being located between the solid material supply and the injection unit.

17. The system of claim 16, wherein the perturbing system is any one of the system taken in the list constituted of: pneumatic vibration system, mechanical vibration system, acoustic vibration system, piezoelectric vibration system, electromagnetical vibration system.

18. A method for mixing a liquid material and a solid material, said method comprising the steps of:
i) mixing the liquid material and the solid material to form a liquid/solid slurry;
ii) separating and extracting simultaneously from said liquid/solid slurry surplus of gas coming from the mixing of the liquid material and the solid material; and
iii) extracting from said liquid/solid slurry a liquid/solid material substantially without gas.

19. The method of claim 18, further comprising the step of re-injecting the liquid/solid slurry not extracted in step iii) in the liquid/solid slurry of step i).

20. The method of claim 18, wherein the method applied to mix a cement slurry, the liquid material being an aqueous solution and the solid material being dry cement.

21. The method of claim 18, wherein the step ii) of separating and extracting simultaneously surplus of gas is done by conical cyclonic effect.

22. The method of claim 18, further comprising the step of pre-mixing the liquid material and the solid material before the step i) of mixing the liquid material and the solid material.

23. The method of claim 22, wherein the step of pre-mixing the liquid material and the solid material comprises a vibration step to enhance delivery of the solid material.
